(19) United States
(12) Patent Application Publication
(10) Pub. No.: US 2010/0256848 A1
(43) Pub. Date: Oct. 7, 2010

(54) DRIVE ASSIST DEVICE AND METHOD FOR MOTOR DRIVEN TRUCK

(76) Inventors: Masataka SASAKI, Hitachi (JP); Akira Kikuchi, Hitachi (JP); Motoo Futami, Hitachioota (JP); Kichio Nakajima, Kasumigaura (JP); Tomohiko Yasuda, Kashiwa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/699,097

(22) Filed: Feb. 3, 2010

(30) Foreign Application Priority Data
Apr. 2, 2009 (JP) JP 2009-023282

(51) Int. Cl. G06F 19/00

(52) U.S. Cl. 701/22

(57) ABSTRACT

A drive assist device for a diesel-electric driven truck is provided to guide and assist a driver in starting to coast so that appropriate coasting deceleration suitable for load weight is realized. The drive assist device includes a course information database that stores information about a course, a truck body information database that stores information about the truck body, a current location determination unit that calculates current location information, a coast initiation timing calculation unit that calculates timing of coasting based on a current location and velocity of the truck and a target velocity at a predetermined point ahead of the truck, those of which being obtained from the databases and input information, the timing of coasting being used to achieve the target velocity at the predetermined point and a guidance unit that informs a truck driver of the timing of coasting according to an output of the calculation unit.

### BACKGROUND OF THE INVENTION

1. Field of the Invention

The present invention relates to a drive assist device for mining trucks driven by an electric motor, and particularly to a drive assist device and a drive assist method for instructing a driver of the time to start to coast.

2. Description of the Related Art

There are two kinds of well-known drive systems for haul trucks used in mines: a mechanical transmission in which torque is mechanically transferred from a primary power source to tires; and a diesel-electric transmission, as disclosed in JP-A No. 2001-1077621, in which a primary power source drives an electrical generator to generate electric power that drives a drive motor.

The truck with the diesel-electric transmission does not use a mechanical brake to damp itself, but employs a braking system in which a motor generates a braking torque and inner resistors consume regenerative energy generated by the motor. The present invention especially relates to a drive assist device for such a motor driven truck.

JP-A No. 2007-69787 discloses a hybrid vehicle in which a driver who needs to reduce the speed of his/her travelling vehicle by releasing the accelerator can choose any deceleration speed.

### SUMMARY OF THE INVENTION

Reduction of fuel consumption significantly contributes to the reduction of the operational costs of mining trucks. One of the possible methods for reducing fuel consumption is to retard the trucks, which can make engine's fuel consumption low. However, trucks with diesel-electric transmissions tend to decrease the rate of consumed fuel against output of a primary power source, in short, the fuel consumption rate with an increase in truck speed, and therefore, retardation of the truck may consume more fuel.

In addition to the above method, a fuel-efficient driving method recommended for passenger vehicles is coasting. During coasting the vehicle propels with inertial energy; however, it is difficult for a driver to estimate an appropriate coasting distance because the mining trucks carry loads that are heavier than truck's body weights and are different in amount every time the loads are put on the trucks. If the driver overestimates the coasting distance by mistake, the truck reduces speed more than necessary and consequently requires extra acceleration energy. This reduces benefits of the fuel-efficient driving method.

Neither JP-A No. 2001-107762 nor JP-A No. 2007-69787 can assist the driver to overcome such difficulties.

The present invention has been made in view of the load weight and other factors and provides a drive assist device suitable for motor driven trucks designed for mining.

In an aspect of the present invention, a drive assist device of a truck driven by a motor using electrical energy includes a course information database that stores information about a course in which the truck travels, a truck body information database that stores information about the body of the truck, a current location determination unit that receives or calculates current location information, a coast initiation timing calculation unit that calculates timing of coasting based on a current location and velocity of the truck and a target velocity at a predetermined point ahead of the truck, those of which being obtained from the databases and received information, the timing of coasting being used to achieve the target velocity at the predetermined point, and a guidance unit that informs a truck driver of the timing of coasting according to an output of the coast initiation timing calculation unit.

In this description, as long as the truck is driven by a general motor, coasting can be started by releasing the driver's foot from the accelerator to make a torque command zero or by shifting a gear to neutral.

In preferred embodiments of the present invention, the coast initiation timing calculation unit, which is designed for achieving a target velocity at a predetermined point, calculates a coasting distance in consideration of body weight, inertia of a driving system of the truck and velocity and gives a truck driver an instruction to start coasting at the appropriate point.

According to the preferred embodiments of the present invention, the truck driver is provided with the appropriate instruction to start coasting operation, such as release of the accelerator, thereby realizing fuel efficient driving.

Furthermore, according to the detailed embodiments of the present invention, inertia and load weight are used to set an optimal coasting distance, thereby realizing fuel efficient driving for any load weight.

The other features of the present invention will be explained in the following embodiments.

### BRIEF DESCRIPTION OF THE DRAWINGS

Embodiments of the present invention will be described in detail based on the attached drawings, wherein:

FIG. 1 is a schematic diagram of a diesel-electric driven mining truck system with a drive assist device therein according to a first embodiment of the present invention;

FIG. 2 is a function block diagram schematically showing the inside of the drive assist device according to the first embodiment of the present invention;

FIG. 3 schematically shows the data contents relevant to course information in the drive assist device according to the first embodiment of the present invention;

FIG. 4 schematically shows the data contents relevant to truck body information in the drive assist device according to the first embodiment of the present invention;

FIGS. 5A to 5E illustrate an example of course and driving conditions in the first embodiment;

FIG. 6 is a schematic diagram of a diesel-electric driven mining truck system with an external drive assist device according to a second embodiment of the present invention;

FIG. 7 is a function block diagram schematically showing the inside of the drive assist device including a running resistance calculation unit according to a third embodiment of the present invention; and

FIGS. 8A to 8E illustrate an example of course and driving conditions, in which the coast starting point in a stored driving pattern is corrected, according to the third embodiment of the present invention.

### DETAILED DESCRIPTION OF THE INVENTION

Descriptions will be made below about a mining truck to which the present invention is applied, and especially about a diesel-electric transmission truck in which a prime power source drives an electric generator to generate electric power that rotates an electric motor to drive tires.

### First Embodiment

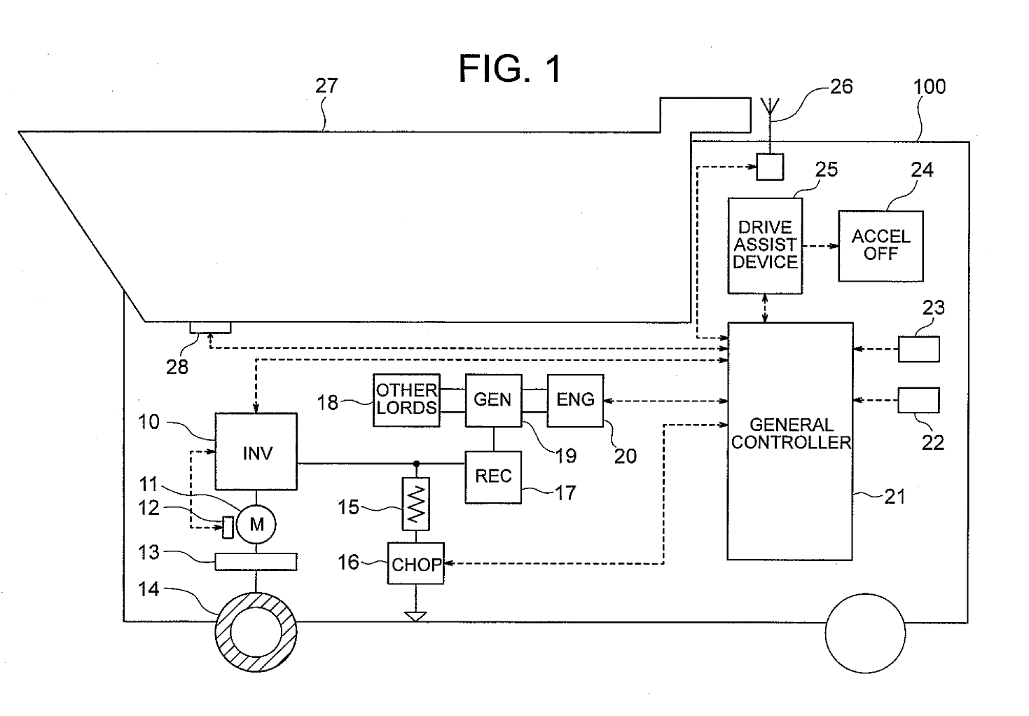

FIG. 1 is a schematic diagram of the diesel-electric driven mining truck system with a drive assist device therein according to the first embodiment of the present invention.

In a diesel-electric driven truck 100 of FIG. 1, an engine 20 drives an AC generator 19 to output AC power that is rectified by a rectifier 17 to obtain DC power. The obtained DC power is converted by an inverter 10 into three-phase AC power with variable voltage and variable frequency to drive an induction motor 11 while adjusting the speed of the motor 11. The induction motor 11 is connected with a drive tire 14 via a decelerator 13 and propels the truck 100.

Brakes applied on the truck 100 causes the induction motor 11 to generate regenerative electric power that is dissipated as heat by a grid resistor 15 through control of a chopper circuit 16.

The AC generator 19 is connected with some other loads 18 including accessory equipment such as an oil pump.

In order to control the components the motor 11 is provided with a velocity sensor 12 that measures the RPM of the motor. A general controller 21 controls the engine 20, inverter 10 and chopper circuit 16 in response to the instruction made by an accelerator 23 and a brake pedal 22, while taking into consideration information about loads from a weight sensor 28 attached to a bucket 27 for carrying loads and information from a positioning sensor 26 that locates the truck body with the use of signals from a satellite.

In addition to the above components the truck 100 includes a drive assist device 25 according to the embodiment of the present invention and a guidance display 24.

Although an actual truck has two pairs of inverters 10, induction motors 11, decelerators 13, drive tires 14 and velocity sensors 12, FIG. 1 shows only one of each. The induction motor 11 may be a magnetic motor. The decelerator 13 in FIG. 1 can be omitted if it is not needed.

Next, basic actions of the truck with the system shown in FIG. 1 will be described.

Operation signals created by the accelerator pedal 23 and brake pedal 22 are input into the general controller 21 and used to control the magnitude of the driving force and braking force, respectively.

When the accelerator pedal 23 is pressed to drive the truck, the general controller 21 provides a rotation command to the engine 20, and the engine 20 rotates as commanded.

The engine 20 mechanically connected to the AC generator 19 actuates the AC generator 19 with its rotation to generate AC power. The AC power is converted by the rectifier 17 into DC power that is then input to the inverter 10.

The DC power input to the inverter 10 is converted into AC power commensurate with a torque command, which is fed from the general controller 21 to the inverter 10, and the RPM ω of the motor determined by the velocity sensor 12, to actuate the induction motor 11.

A driving torque generated in the induction motor 11 is changed by a transmission 13 into a driving force for the drive tire 14 that propels the truck.

The AC generator 19 is controlled by the general controller 21 so as to generate an appropriate amount of AC power required for the induction motor 11.

On the other hand, when the accelerator pedal 23 of the moving truck is released and then the braking pedal 22 is pressed, the general controller 21 controls the AC generator 19 to stop generating AC power. Subsequently, the general controller 21 sends a command to the inverter 10 to develop a regenerative braking torque on the induction motor 11. The braking torque applied to the induction motor 11 is changed by the transmission 13 into a braking force for the drive tire 14 and retards the truck. The regenerative energy generated with the braking torque flows from the induction motor 11 to the inverter 10 where AC power is converted into DC power. The converted DC power flows to the grid resistor 15 by operating the chopper circuit 16 and is then dissipated as heat.

Next, features of the present invention will be described.

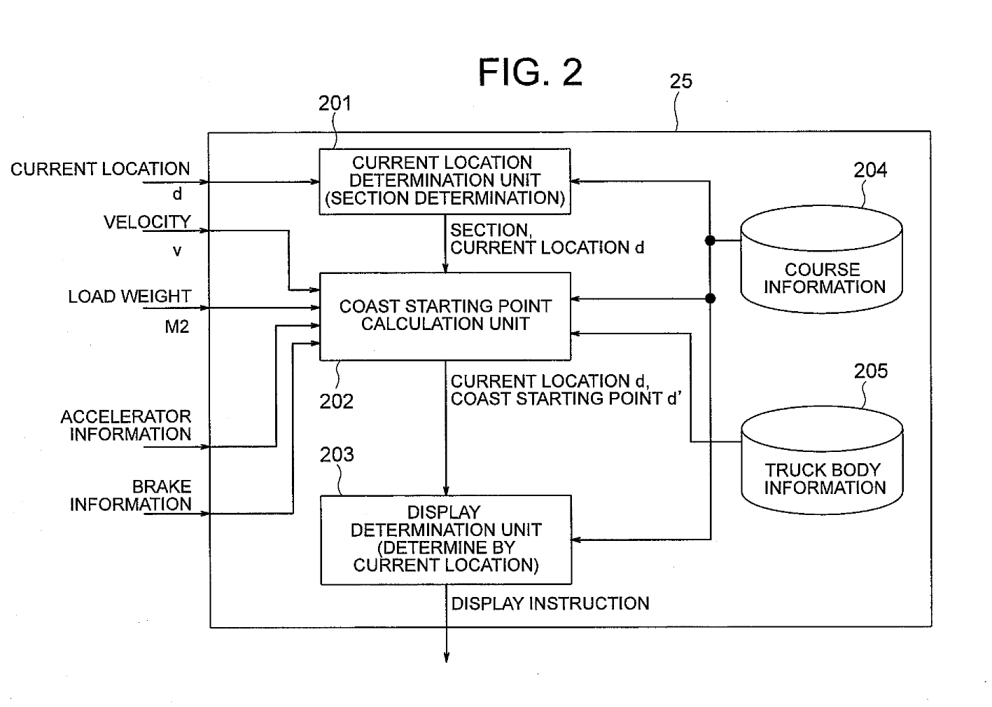

FIG. 2 illustrates a control block configuration inside the drive assist device 25 according to the first embodiment of the present invention.

Following is a description about the functions of the drive assist device 25.

The drive assist device 25 includes a current location determination unit 201, a coast starting point calculation unit 202 and a display determination unit 203 functioning as main calculation units and also includes course information 204 and truck body information 205, which are databases. Main input items are, in addition to accelerator information and brake information, current location information d obtained by the positioning sensor 26, velocity v obtained by the velocity sensor 12 and load weight M2 of the bucket 27 obtained by the weight sensor 28.

The information items are transferred to the drive assist device 25 via the general controller 21.

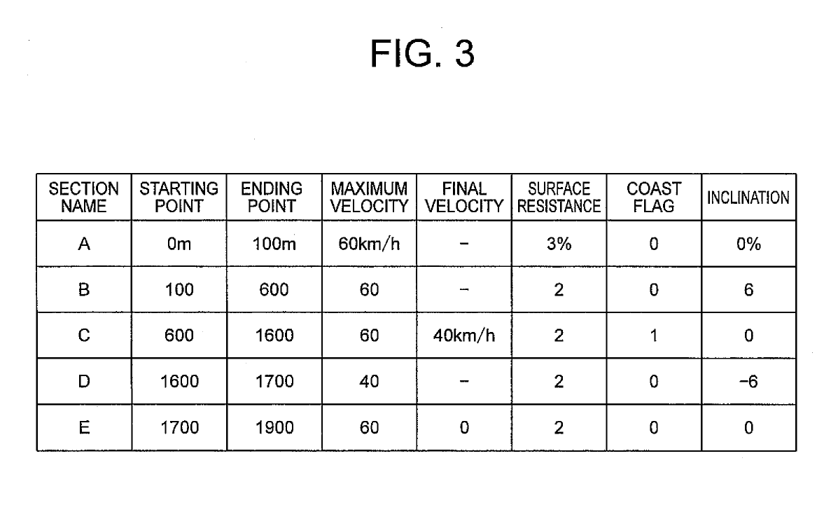

FIG. 3 shows the contents of the course information in the drive assist device 25 according to the first embodiment of the present invention.

The course information in FIG. 3 shows an exemplary climbing course in an open-pit mine. The course is divided into A, B, C, D and E sections each having data of a starting point, an ending point, a maximum speed, a final velocity representing a speed of the truck at the ending point of the section, surface resistance, a coast flag used to determine whether the section is the one the truck needs to reduce speed by coasting, and inclination. For the maximum speed, speed limits of respective sections are mainly input in the database.

At Section A, the truck having a load thereon starts traveling the course. Section B is an ascending slope at a gradient of 6%, while Section C is a flat route of 1,000 m. The section D is a descending slope at a gradient of −6%, while Section E is the last part of the course. The truck travels the entire course of 1,900 m and stops.

The final velocity is set for Section C, in which the truck needs to reduce its speed toward the entrance of the descending section D, and for Section E which is the last section of the course. The final velocity of Section C is set to the same value as the maximum speed of Section D.

The coast flag is set to “1” only for Section C to allow the truck to perform coasting deceleration. The coasting deceleration is a technique of reducing truck speed and is performed by turning off the accelerator with the brake pedal remaining off and cancel inertial energy of the truck with the running resistance. The coast flag is set to “0” for the other sections and therefore the truck does not coast in the sections.

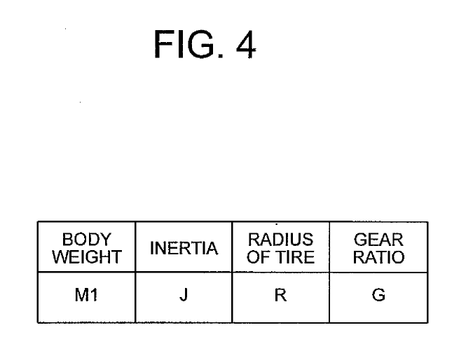

FIG. 4 shows contents of the truck body information in the drive assist device 25 according to the first embodiment of the present invention.

The truck body information includes truck body weight M1, inertia J which is the sum of inertia of a tire and an induction motor, tire radius R, and gear ratio G of the decelerator.

First of all, the drive assist device 25 starts processing with the input of the current location information d. The input of the current location information d causes the current location determination unit 201 to determine which one of the sections listed in the course information the truck is in at this point of time.

Assuming that the current location information d indicates 1,000 m from the course's starting point of 0 m, it can be determined that the truck is running in Section C that starts at 600 m and ends at 1,600 m in consideration of the distance relationship between the starting points and ending points listed in the course information.

Next, the current location information d and the information concerning the present section are input to the coast starting point calculation unit 202 that reads out the coast flag value of the present section from the course information. If the coast flag indicates “1”, the coast starting point calculation unit 202 calculates the position to start coasting.

Following is a description about expressions to calculate coasting distance.

Force and torque applied to the body and motor of the truck running on a road surface are expressed by the following motion equations.

$$\begin{matrix}[ Equation 1 ] & \\ \int \frac{d w}{d t} = TE - TL & ( 1 ) \\ [ Equation 2 ] & \\ TL = \frac{FR}{G} & ( 2 ) \\ [ Equation 3 ] & \\ ( M 1 + M 2 ) \frac{d v}{d t} = 2 F - μ ( M 1 + M 2 ) g & ( 3 )\end{matrix}$$

Let is be assumed that F is driving force of a drive tire, μ is running resistance coefficient, ω is angular velocity of the motor, v is velocity, TE is output torque of the motor, TL is load torque of the motor, and g is gravitational acceleration.

It should be noted that the inertia J is obtained by converting the total inertia of the motor inertia and tire inertia to a motor conversion value, and J, TE, TL and F are values for one of the drive tires.

In addition, when the driving mode in which the truck is placed is coasting mode, in other words, when the motor's output torque is TE=0 and there is no slippage between the tire and road surface, the relationship between the angular velocity ω of the motor and the velocity v is established by expression 4.

$$\begin{matrix}[ Equation 4 ] & \\ ω = \frac{Gv}{R} & ( 4 )\end{matrix}$$

The expressions 1 to 4 are integrated with respect to the velocity v into a motion equation as shown by expression 5.

$$\begin{matrix}[ Equation 5 ] & \\ ( M 1 + M 2 + \frac{1 {G}^{2} J}{{R}^{2}} ) \frac{d v}{d t} = - μ ( M 1 + M 2 ) g & ( 5 )\end{matrix}$$

In the expression 5, weight is represented as the sum of the truck body weight M1, load weight M2 and 2G²J/R², which is a weight conversion value of inertia. The expression 5 also indicates that the force μ(M1+M2)g produced by running resistance reduces the velocity of the truck.

When the rolling resistance coefficient μ is constant, an energy conservation law is established in expression 5. If a coasting deceleration distance is denoted by Δd, expression 6 holds as follows.

$$\begin{matrix}[ Equation 6 ] & \\ \frac{1}{2} ( M 1 + M 2 + \frac{2 {G}^{2} J}{{R}^{2}} ) ( {v}_{0}^{2} - {v}_{1}^{2} ) = μ ( M 1 + M 2 ) g Δ d & ( 6 )\end{matrix}$$

In expression 6, v₀ denotes velocity at the initiation of coasting and v₁ denotes velocity at the termination of coasting.

Furthermore, expression 7 is obtained by modifying the expression 6.

$$\begin{matrix}[ Equation 7 ] & \\ Δ d = \frac{1}{2 μ g} ( 1 + \frac{2 {G}^{2} J}{{R}^{2} ( M 1 + M 2 )} ) \cdot ( {v}_{0}^{2} - {v}_{1}^{2} ) & ( 7 )\end{matrix}$$

In the coast starting point calculation unit 202, the following information items are applied to expression 7: surface resistance, inclination and final velocity from the course information; truck body weight M1, inertia J, tire radius R and gear ratio G from the truck body information; and velocity v and load weight M2 input to the assist device 25.

The running resistance coefficient μ is obtained with a surface resistance of 2% and inclination of 0%, which are data of Section “C”, by μ=sin(tan⁻¹(0.02+0.00))=0.02

As to velocity v, the coast initiation velocity is denoted by v0 and the coast termination velocity obtained from the course information is denoted by v1.

Thus calculated coasting deceleration distance Δd is subtracted from the ending point of 1600 m of Section “C”, i.e., (1600−Δd) m, to obtain a coast starting point d′.

According to the expression 7, the greater the load weight M2 is, the shorter the coasting distance Δd is, while the smaller the load weight M2 is, the longer the coasting distance Δd is. The coasting distance Δd also varies depending on the magnitude of the inertia J. Therefore, the expression 7 calculates an appropriate coasting distance Δd suitable for the load weight and inertia.

Next, operations of the display determination unit 203 will be described.

The display determination unit 203 is fed with the current location information d and coast starting point d′ from the coast starting point calculation unit 202 and the ending point of the associated section from the course information 204.

If the display determination unit 203 determines that the current location d establishes the relationship represented by expression 8, it is determined that the current location of the truck is the position for the truck to start coasting and reducing speed. Then a command to display “ACCEL OFF” is output to the guidance display 24.

d′≦d≦ending point of the associated section (8)

On the other hand, if it is determined that the current location d is out of the range represented by the expression 8, a command to not display “ACCEL OFF” is output to the guidance display 24 because the current location of the truck is out of the coasting deceleration range.

With the display command output from the display determination unit 203 in the drive assist device 25, the guidance display 24 displays an appropriate instruction to perform coasting deceleration according to the command to display or not display “ACCEL OFF” so that the driver of the truck can turn on or off the accelerator pedal 23 according to the instruction indicated by the guidance display 24.

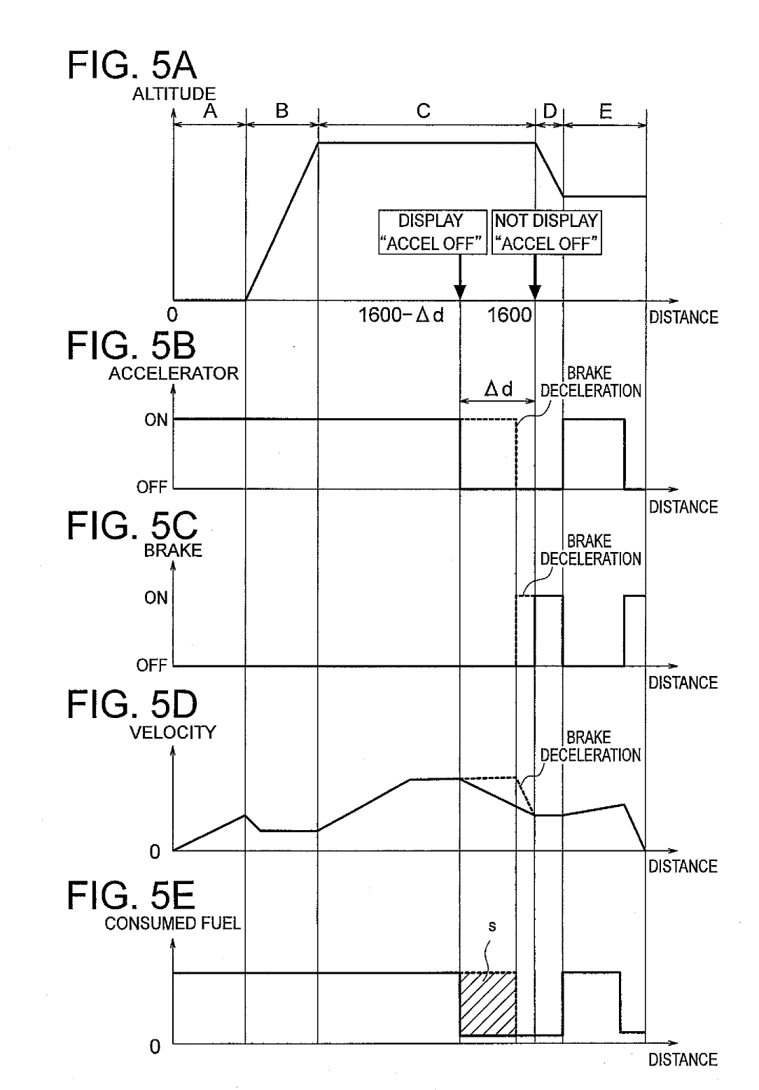

Next, the benefits provided by the present invention will be described with reference to the conditions of a truck traveling the course as shown in FIG. 5.

FIGS. 5A to 5E illustrate an example of a course and driving conditions in the first embodiment of the present invention. More specifically, in a schematic form, FIG. 5A shows topographic features of the driving course, FIG. 5B shows the On-Off state of the accelerator, FIG. 5C shows the On-Off state of the brake, FIG. 5D shows velocity, and FIG. 5E shows fuel consumption, when the above-described truck drives the course shown in FIG. 3. The lateral axes represent the course distance from the starting point of 0 m.

The truck drives Section A with the accelerator turned on from the stating point while picking up speed. Because Section B is an ascending slope, the truck decelerates slightly while keeping the accelerator in the ON state. In flat Section C, the truck is again accelerated with the accelerator turned on to develop velocity.

In Section C in which the course information thereof includes a final velocity and coast flag set to “1”, the drive assist device 25 calculates a coasting deceleration distance Δd whenever a velocity of the truck is input and monitors whether the current location d reaches the coast starting point d′=(1600−Δd). When the current location d has reached the coast starting point d′, “ACCEL OFF” is displayed on the guidance display 24 and the driver releases the accelerator pedal 23.

Because the brake pedal 22 maintains its OFF state, the inertial energy of the truck is consumed only by the running resistance so that the truck slowly reduces the speed.

The truck enters Section D at the same velocity as the maximum velocity of Section D, and therefore the driver turns on the brake pedal to go down the descending slope. In the last section E in which the final speed is set to 0 km/h and the coast flag is set to “0”, the driver does not see “ACCEL OFF” on the display and depresses the brake pedal in the vicinity of the ending point of Section E to a halt.

Referring to the fuel consumption during the driving of the course, the engine 20 consumes a significant amount of fuel with accelerator ON signals for the duration from Section A to the middle of Section C where the accelerator is released. However, because the accelerator is kept off from the point of 1600−Δd to Section E, the engine 20 does not need to drive the AC generator 19 to output power, but only other loads 18, resulting in less fuel consumption. The AC generator 19 does not output power in the last part of Section E even though the brake is turned on, and therefore the loads 18 are the only ones the engine 20 has to handle, resulting in less fuel consumption.

Dashed lines in FIGS. 5B, 5C, 5D and 5E indicate the state of accelerator, brake, velocity, and fuel consumption, respectively, when the truck does not use the coasting deceleration technique according to the embodiment of the present invention, but reduces its speed by depressing the brake pedal in Section C. Speed reduction by depressing the brake pedal in Section C consumes extra fuel equivalent to the amount shown by a hatch pattern S because the distance required to reduce the speed is short.

As described above, the drive assist device 25 of the first embodiment can calculate an appropriate coasting distance by using the truck body weight, load weight, surface resistance, truck body information, course information, and velocity information and can realize a fuel-efficient truck with the guidance display 24 instructing the initiation of coasting at an appropriate position.

In the first embodiment, the drive assist device 25 can be integrated with the general controller 21. Such a drive assist device 25 and a general controller 21 can share programs and data stored in the integrated body and can provide the same effect. In addition to the instruction displayed on the guidance display 24, a voice instruction may be more effective for the driver.

Although the drive assist device 25 in the above description is designed to calculate coasting distance and to display instructions, it is also possible to calculate braking distance with the use of braking force characteristics added to the truck body information and to display appropriate instructions to turn on the brake pedal on the guidance display.

### Second Embodiment

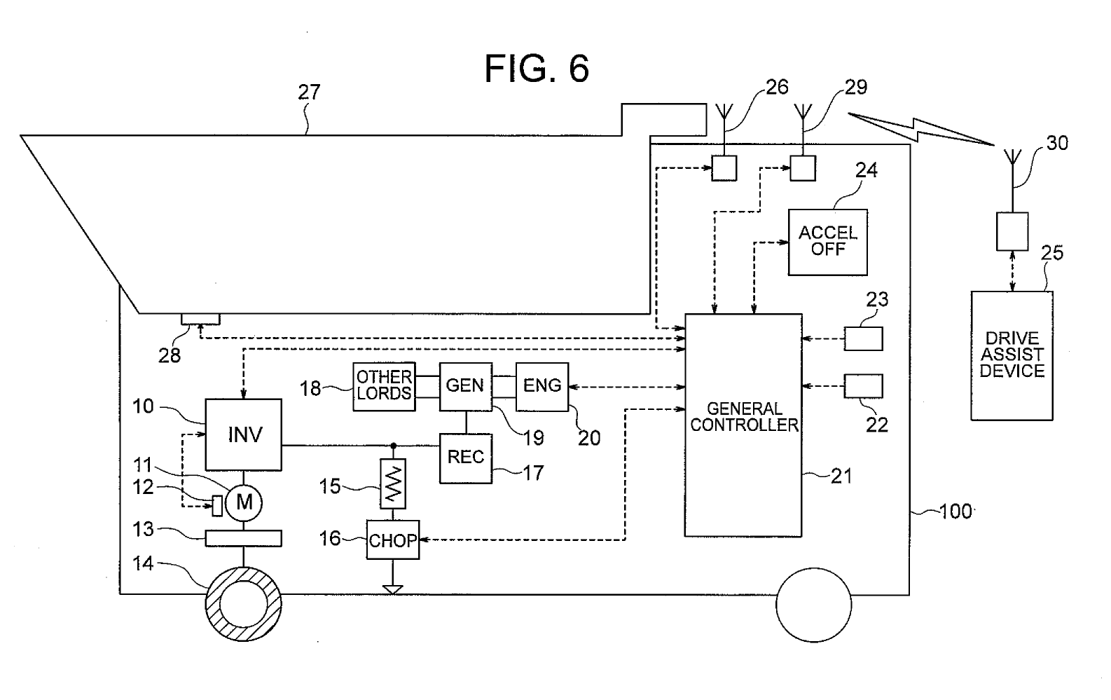

FIG. 6 is a schematic diagram of the diesel-electric driven mining truck system installed with an external drive assist device according to the second embodiment of the present invention. The drive assist device 25 is connected to a wireless communication device 30 and can wirelessly communicate with the truck. The truck 100 is provided with a wireless communication device 29 that is connected to the general controller 21 so that the general controller 21 of the truck 100 and the drive assist device 25 can mutually communicate through the wireless communication devices 29, 30. The guidance display 24 is connected to the general controller 21. The drive assist device 25 receives information for calculating coasting deceleration distance from the general controller 21 through wireless communication, and feeds back an instruction to display the initiation of coasting through the wireless communication to the general controller 21 that sends the instruction to the guidance display 24.

In the second embodiment, the provision of the wireless communication device to the drive assist device 25 placed outside the truck allows the drive assist device 25 to establish mutual communication with multiple trucks and to provide an instruction to start coasting to the multiple trucks at the same time.

### Third Embodiment

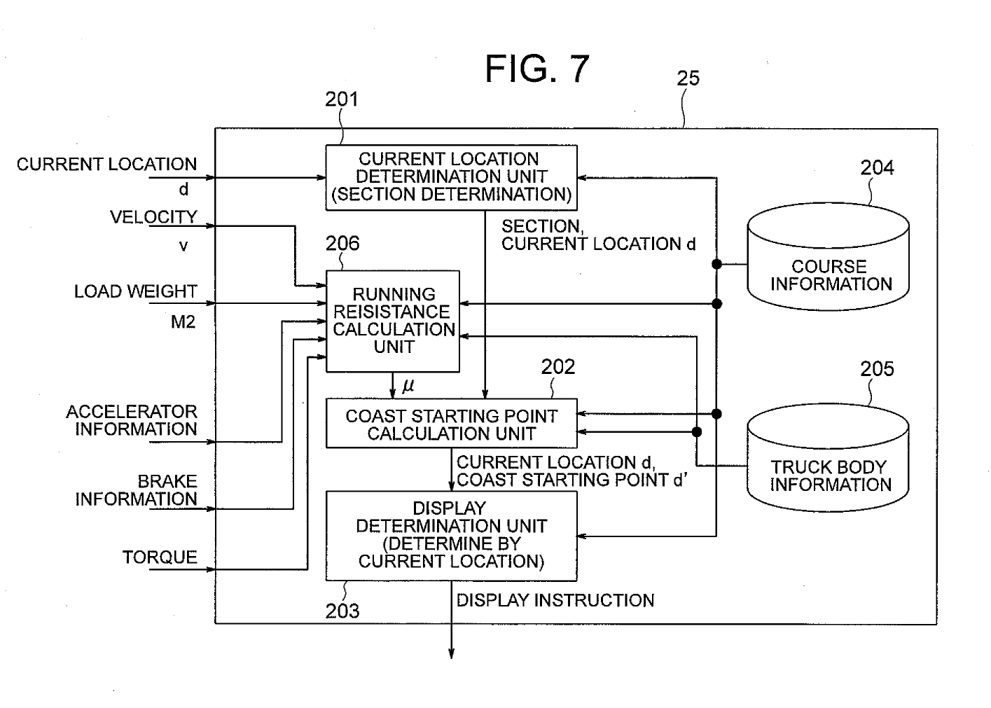

FIG. 7 is a function block diagram schematically showing the drive assist device 25 including a running resistance calculation unit according to the third embodiment of the present invention.

Although, in the first embodiment, the running resistance is calculated from surface resistance and inclination stored in the course information, the drive assist device 25 in the third embodiment includes a running resistance calculation unit 206 that calculates running resistance while the truck is travelling. The running resistance is used to calculate coasting deceleration distance Δd. The other components are the same as those in FIG. 2.

Next, methods for calculating a running resistance coefficient and a coast starting point will be described.

The expressions 1 to 4 are integrated to obtain expression 9 for the running resistance coefficient μ.

$$\begin{matrix}[ Equation 8 ] & \\ μ = \frac{1}{( M 1 + M 2 ) g} [ \frac{2 G}{R} TE - ( M 1 + M 2 + \frac{2 {G}^{2} J}{{R}^{2}} ) \frac{d v}{d t} ] & ( 8 )\end{matrix}$$

Thus, with output torque TE of the induction motor 11 input from the general controller 21 to the assist device 25 and the time-varying rate of velocity v represented by dv/dt, the running resistance coefficient μ can be determined.

Upon receipt of the running resistance coefficient μ input from the running resistance calculation unit 206, the coast starting point calculation unit 202 performs calculation of expression 7 to obtain a coasting deceleration distance Δd using the running resistance coefficient μ instead of the surface resistance and inclination in the course information used in the first embodiment.

The drive assist device of the third embodiment handles changes in road surface conditions by calculating the running resistance of the travelling truck and the coasting deceleration distance without using the surface resistance and inclination stored in the course information. The road surface conditions in mines vary with weather and maintenance; however, the third embodiment can provide a drive assist device capable of handling the changes in the road surface conditions.

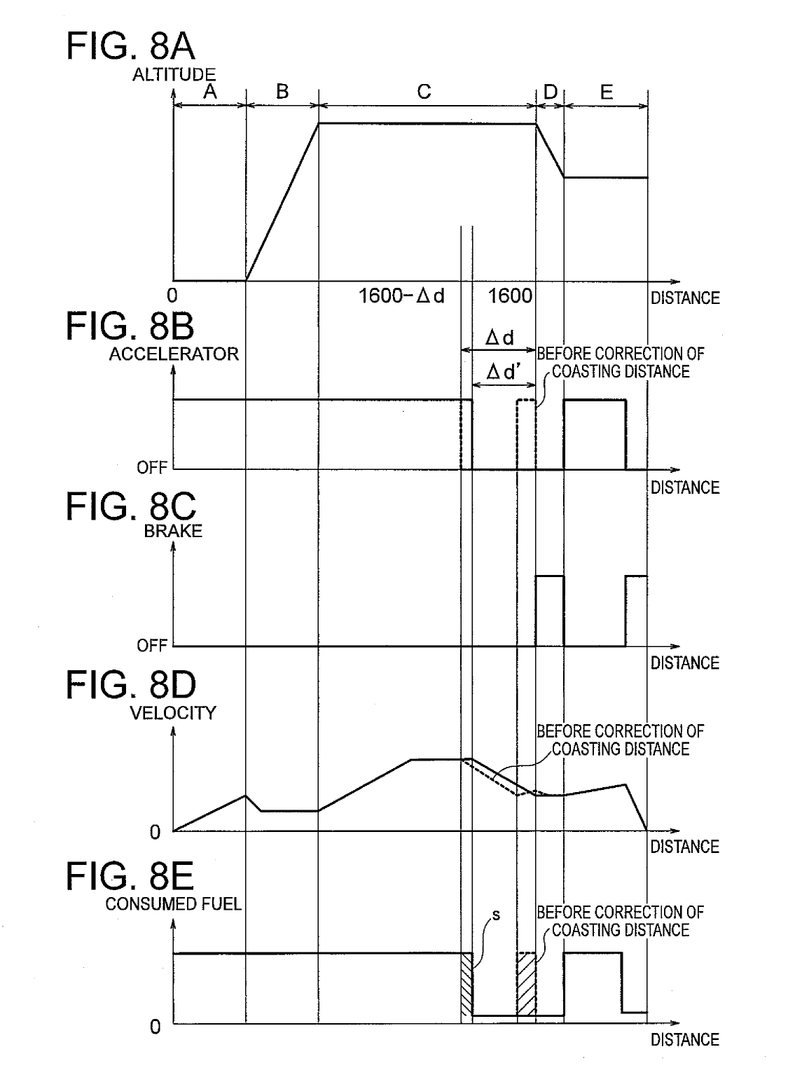

FIGS. 8A to 8E illustrate an example of a course and driving conditions, in which the coast starting point in a stored driving velocity pattern is corrected according to the third embodiment of the present invention. FIGS. 8A to 8E correspond to FIGS. 5A to 5E, respectively, and the velocity of FIG. 5D means the driving velocity pattern. If the truck travels the coasting deceleration distance Δd as shown in FIG. 8B based on the initially stored driving velocity pattern, the truck reaches a target deceleration velocity before the descending section D as indicated by a dashed line. In order to avoid reaching the target deceleration velocity, the driver needs to depress the accelerator again at the near end of the flat section C until the entrance of the descending section D, which consumes extra fuel.

The consumption of extra fuel can be prevented by estimating surface resistance by calculations to correct the driving velocity pattern so that the truck is guided to coast a distance of Δd'. This allows the truck to reduce the speed to the target speed at the entrance of the descending section D as indicated by a solid line, thereby saving an amount of the fuel to be consumed.

As described above, a drive assist device capable of saving fuel consumption can be provided with a unit that stores the driving velocity pattern and a unit that corrects the coast starting point indicated in the driving velocity pattern with reference to driving conditions and road surface conditions.

According to the embodiments, installation of a drive assist device that instructs a coast starting point to a diesel-electric driven mining truck allows the truck to coast and decelerate an appropriate coasting deceleration distance and contributes to making the truck fuel efficient. In addition, frequent use of coasting deceleration, instead of braking deceleration, relatively reduces the usage of the chopper circuit and grid resistor, resulting in reduction of heat fatigue of the chopper circuit and grid resistor. This contributes to an increase in life time of the device.

It should be understood by those skilled in the art that various modifications, combinations, sub-combinations and alterations may occur depending on design requirements and other factors insofar as they are within the scope of the appended claims or the equivalents thereof.

What is claimed is:

1. A drive assist device for a truck driven by a motor using electrical energy comprising:
a course information database that stores information about a course in which the truck travels;
a truck body information database that stores information about the truck body;
a current location determination unit that receives or calculates current location information;
a coast initiation timing calculation unit that calculates timing of coasting based on a current location, a velocity of the truck and a target velocity at a predetermined point ahead of the truck, those of which being obtained from the databases and input information, the timing of coasting being used to achieve the target velocity at the predetermined point; and
a guidance unit that informs a truck driver of the timing of coasting according to an output of the coast initiation timing calculation unit.

2. A drive assist device for a truck driven by a motor using electrical energy comprising:
a course information database that stores information about a course in which the truck travels;
a truck body information database that stores information about the truck body;
a current location determination unit that receives or calculates current location information;
an accelerator pedal release timing calculation unit that calculates timing of release of an accelerator pedal based on a current location, a velocity of the truck and a target velocity at a predetermined point ahead of the truck, those of which being obtained from the databases and input information, the timing of coasting being used to achieve the target velocity at the predetermined point; and
a guidance unit that informs a truck driver of the timing of release of the accelerator pedal according to an output of the accelerator pedal release timing calculation unit.

3. A drive assist device for a truck driven by a motor using electrical energy comprising:
a course information database that stores information about a course in which the truck travels;
a truck body information database that stores information about the truck body;
a current location determination unit that receives or calculates current location information;
a shift timing calculation unit that calculates timing of shift to neutral based on a current location, a velocity of the truck and a target velocity at a predetermined point ahead of the truck, those of which being obtained from the databases and input information, the timing of coasting being used to achieve the target velocity at the predetermined point; and
a guidance unit that informs a truck driver of the timing of shift to neutral according to an output of the shift timing calculation unit.

4. The drive assist device for the motor driven truck according to claim 1, wherein the guidance unit includes a section that guides the driver by voice.

5. The drive assist device for the motor driven truck according to claim 1, wherein the guidance unit includes a section that guides the driver with visual display.

6. The drive assist device for the motor driven truck according to claim 1, wherein the course information includes running resistance of a road surface, the truck body information includes truck weight, load weight of the truck and inertia of a driving system of the truck, and the timing calculation unit includes a coasting distance calculation unit that calculates coasting distance based on the running resistance of the road surface, the truck weight, the load weight of the truck and the inertia of the driving system of the truck.

7. The drive assist device for the motor driven truck according to claim 6, wherein the truck includes a load weight detection unit that provides information about the load weight of the truck.

8. The drive assist device for the motor driven truck according to claim 1, wherein the course information database includes information about driving conditions and road surface conditions of the course.

9. The drive assist device for the motor driven truck according to claim 1, wherein, the truck body information database includes information about truck weight, inertia of the driving system of the truck and radius of a tire of the truck.

10. The drive assist device for the motor driven truck according to claim 6, further comprising a calculation unit that calculates running resistance of the truck while the truck is travelling based on a velocity and driving force of the truck.

11. The drive assist device for the motor driven truck according to claim 1, wherein the drive assist device is installed inside the motor driven truck.

12. The drive assist device for the motor driven truck according to claim 1, wherein the drive assist device is installed outside the motor driven truck and includes a wireless communication unit that enables mutual communication with one or a plurality of trucks.

13. The drive assist device for the motor driven truck according to claim 1, further comprising:
a storage unit that stores a driving pattern representing the location and velocity of the truck; and
a correction unit that corrects a coast starting point set in the driving pattern based on the driving conditions and road surface conditions.

14. The drive assist device for the motor driven truck according to claim 1, further comprising:
a storage unit that stores a driving velocity pattern; and
a correction unit that corrects a coast starting point set in the driving velocity pattern based on the driving conditions and road surface conditions.

15. A method for assisting a truck driven by a motor using electrical energy comprising the steps of:
storing information about a course in which the truck travels in a course information database;
storing information about a truck body in a truck body information database;
determining a current location by receiving or calculating current location information;
calculating timing of coasting based on the current location, velocity of the truck and a target velocity at a predetermined point ahead of the truck, those of which being obtained from the databases and input information, the timing of coasting being used to achieve the target velocity at the predetermined point; and
guiding a truck driver the timing of coasting according to an output obtained in step of calculating timing of coasting.
